(19) United States
(12) Patent Application Publication
(10) Pub. No.: US 2024/0174489 A1
(43) Pub. Date: May 30, 2024

(54) ROLLER GUIDE SHOE FOR GUIDING AN ELEVATOR CAR OR A COUNTERWEIGHT OF AN ELEVATOR

(71) Applicant: Inventio AG, Hergiswil (CH)

(72) Inventors: Patrick Bumann, Eschenbach LU (CH); Volker Zapf, Kriens-Obernau (CH)

(21) Appl. No.: 18/551,887

(22) PCT Filed: Mar. 16, 2022
(86) PCT No.: PCT/EP2022/056768

§ 371 Date: Sep. 22, 2023

(30) Foreign Application Priority Data
Mar. 30, 2021 (EP) 21165967.7

(51) Int. Cl. B66B 7/04

(52) U.S. Cl. CPC B66B 7/046

(57) ABSTRACT

A roller guide shoe for guiding an elevator car or a counterweight includes a support structure formed as a plastics injection-molded part, guide rollers, and lever elements arranged between the support structure and the guide rollers. The respective lever element is an integral molded body made of a plastics material, and applies a preload for the guide roller as a bending part. The lever elements inserted into associated joint cams of the support structure, wherein each joint cam engages in a recess on the associated lever element to predefine an articulation axis. Each lever element has two lever arms that define a V-shape.

### FIELD

The invention relates to a roller guide shoe for guiding an elevator car or a counterweight of an elevator along a guide rail extending in a longitudinal direction.

### BACKGROUND

Elevators for conveying persons and goods contain elevator cars that can be moved up and down in an elevator shaft. The elevator cars can be moved in the vertical elevator shaft via suspension elements, for example in the form of support cables or support belts, by means of a drive unit. In addition to the elevator car, the elevator system usually comprises at least one counterweight that is moved in the opposite direction in the elevator shaft. In this case, the elevator car and the at least one counterweight run in guide rails. Guide shoes are usually used to guide elevator cars and counterweights, it being possible for the guide shoes to be designed as sliding guide shoes or roller guide shoes.

Multi-part roller guide shoes having three rollers, such as have become known from U.S. Pat. No. 5,107,963 or U.S. Pat. No. 7,562,749 are known and commonly used. In these roller guide shoes, air springs or helical compression springs and elastomeric springs are used, in order to achieve good travel comfort. These roller guide shoes are characterized by a complicated structure and large material requirement and are therefore correspondingly expensive.

### SUMMARY

It is an object of the present invention to avoid the disadvantages of the known guide shoes and in particular to provide a roller guide shoe for guiding an elevator car or a counterweight of an elevator, which is characterized by a simple structure. The roller guide shoe should furthermore be cost-effective and be characterized by simple handling with regard to its assembly.

According to the invention, these and other objects are achieved by the roller guide shoe having the features described herein. The roller guide shoe for an elevator for transporting passengers or goods is used to guide an elevator car or a counterweight along a guide rail extending in the travel or longitudinal direction. The roller guide shoe comprises at least one guide roller and a carrier structure having a preferably plate-like base portion for fastening the roller guide shoe to the elevator car or to the counterweight, and at least one web portion which preferably projects away from the base portion at a right angle. The base portion can have fastening means for example in the form of recesses for receiving fastening screws. The web portion is that part of the support structure which is assigned to the guide roller. Preferably, the support structure for each guide roller has a respective web portion for supporting and carrying the at least one guide roller. Roller guide shoes often have three guide rollers. In this case, the support structure would substantially comprise the above-mentioned base portion and three web portions projecting away from the base portion for supporting and carrying the guide rollers. A lever element, preferably designed as a bending part, is arranged between the support structure and the at least one guide roller. A bending part is understood in the present case as a component which can be subjected to bending. The bending refers to the bending part being resiliently bent under load. Thus, with regard to the bending part, it is a question of the spring properties of the bending part, and not of how the part is manufactured. When the roller guide shoe is installed in the elevator, the lever element designed as a bending part can be arranged in the roller guide shoe such that the lever element is bent, as a result of which a preload is built up, by which the guide roller is pressed against the guide rail. The at least one guide roller is mounted so as to be freely rotatable at a free end of the lever element. Clearly, the roller guide shoe is characterized by a particularly simple structure, because the roller guide shoe consists essentially of only three components; namely, the support structure, the lever element and the guide roller. Due to the fact that a lever element, designed as a bending part, is arranged between the support structure and the at least one guide roller in order to apply a preload for the guide roller in the state ready for operation (or when the roller guide shoe is mounted in the elevator), a sufficiently good travel comfort can be achieved. Since no additional spring or insulation elements such as helical compression springs and elastomeric springs have to be used, the present roller guide shoe has considerable cost advantages compared to conventional roller guide shoes. Another advantage of this roller guide shoe is that it is characterized by low maintenance effort during operation.

The support structure, comprising the base portion and the web portion, can be designed as an integral molded body made of a plastics material. Alternatively or additionally, the at least one lever element can also be designed as an integral molded body made of a plastics material. Such molded bodies can be produced easily and cost-effectively. The use of plastics material also results in weight advantages compared to the comparatively heavy conventional roller guide shoes produced from metal materials.

The support structure can be made of a high-strength plastics material, for example PE, PP, PA, PS, PES, POM, PEEK, TPEs, it also being possible for fibers for reinforcing the structure to be mixed with the plastics materials. It is particularly preferred to produce the support structure from a fiber-reinforced plastics material.

It can be particularly advantageous if the support structure, comprising the base portion and the web portion, is an injection-molded part and/or the lever element is an injection-molded part. In this case, injection-molded parts are plastics parts produced in an injection molding process. In this way, a stable and torsion-resistant support structure can be created, in which the base portion and the web portion are monolithically connected to one another.

The at least one guide roller can have an inner bearing bush and an outer wheel rim, which is connected to the bearing bush so as to be freely rotatable, for example via a roller bearing or a plain bearing, for forming the running body. In this case, the bearing bush and the wheel rim can be made of plastics materials. The wheel rim can be constructed, for example, from a plurality of plastics components, as a result of which the travel comfort can be further improved.

In one embodiment, the lever element can be inserted or snapped onto joint cams arranged laterally on the web portion, the joint cam engaging in a recess on the lever element, for predefining an articulation axis.

A locking member, preferably designed as a projection, can be provided in the web portion of the support structure, as an abutment for the lever element for supporting and for forming a stop for preventing a pivoting movement of the lever element about the articulation axis. The projection is integrally formed on the support structure and can be easily created by means of the previously mentioned injection molding method. Instead of such projections connected monolithically to the support structure, however, separate locking members could also be used, which are detachably or fixedly fastened to the support structure.

For easy handling with regard to assembly, it can be advantageous if the locking member is a detent in which the lever arm is engaged with the detent. The detent can contain a contact surface which contacts the lever element when the latching connection is present, and a ramp-like run-on surface adjoining the contact surface. This ramp-like run-on surface can be inclined in such a way that, when the lever element is mounted, the lever element can travel along the run-on surface until the end position or when the latching connection is present; the lever arm is now in contact with the contact surface, which finally achieves the support.

The lever element can have two lever arms which define a V-shape. A lever element that is V-shaped in this way is particularly well suited as a bending part, by which the preload for the guide roller can be applied. Thanks to the V-shape, the two rigidly interconnected lever arms ensure spring properties in a simple manner, thanks to which the bending can be made possible for generating the preload. The V-shape is particularly favorable when the lever part is a plastics part.

An advantageous bending part results when the lever arms enclose an angle of 120° to 150°.

The lever element can then preferably have reinforcing ribs or webs extending transversely and preferably provided on a lateral outer contour, for stiffening.

In the region of the free end of the lever arm, the lever element can have an axle journal formed laterally on the lever element for receiving the guide roller. For example, for this purpose, the guide roller can be inserted via the bearing bush into the axle journal.

The roller guide shoe can have three guide rollers. The three guide rollers can consist of two guide rollers which are oriented toward one another and which serve for guiding along the parallel lateral guide surfaces of the guide rail, and one guide roller which serves for guiding along the front guide surface of the guide rail connecting the lateral guide surfaces to one another. In this case, each guide roller is preferably associated with one lever element in each case.

The support structure for the roller guide shoe comprising three rollers can have a preferably plate-like base portion and three web portions preferably projecting away from the base portion at right angles. The web portions can form a “T” in plan view.

If the roller guide shoe has three guide rollers, it can be advantageous if at least two of the three lever elements and in particular the lever elements comprising the guide rollers, which serve to guide associated guide rollers along the lateral guide surfaces of the guide rail, have in each case two coaxial axle journals for receiving guide rollers, which are arranged on opposite sides of the lever element. Thus, identical lever elements can be used for the two lever elements which are provided for the lateral guidance. This has the advantage that the same tool can be used during injection molding, which has a favorable effect on the manufacturing costs.

For the roller guide shoe comprising three rollers, the support structure can preferably have web portions extending away from the base portion at right angles, for supporting the guide rollers, the web portions being connected to one another via a connection region. An emergency guide can be integrated in the support structure in such a way that an emergency guide channel extending along the web portions is provided in the connecting region of the web portions. An emergency guide channel of this kind is characterized by excellent emergency guidance properties, for an emergency, due to its length. In this case, the length of the emergency guide channel can substantially correspond to the outer dimension of the support structure with respect to the longitudinal direction.

The emergency guide channel can be formed by channel wall portions, the channel wall portions forming a U-shape. In other words, in a plan view, the channel wall portions together form a U-shaped profile part body. This U-shaped profile part body is preferably an integral component of the support structure and is connected monolithically to the support structure. The web portions can each adjoin the channel wall portions at right angles. A channel wall portion is consequently assigned to each web portion, the respective web portions open into associated channel wall portions. Another advantage of such an embodiment of the emergency guide channel is that it can bring about additional stiffening of the support structure.

A further aspect of the invention can relate to an elevator car or a counterweight for an elevator, the elevator car or the counterweight being equipped with the previously described roller guide shoes. A further aspect of the invention can finally relate to an elevator installation comprising an elevator car and a counterweight which is connected to the elevator car via suspension elements and can be moved in the opposite direction to the elevator car, the elevator car or the counterweight being equipped with such roller guide shoes for guiding the elevator car or the counterweight on guide rails.

### DESCRIPTION OF THE DRAWINGS

Additional advantages and individual features of the invention can be derived from the following description of an embodiment and from the drawings. In the drawings:

FIG. 1 is a perspective view of a roller guide shoe for an elevator, and

FIG. 2 is an exploded view of the roller guide shoe from FIG. 1.

### DETAILED DESCRIPTION

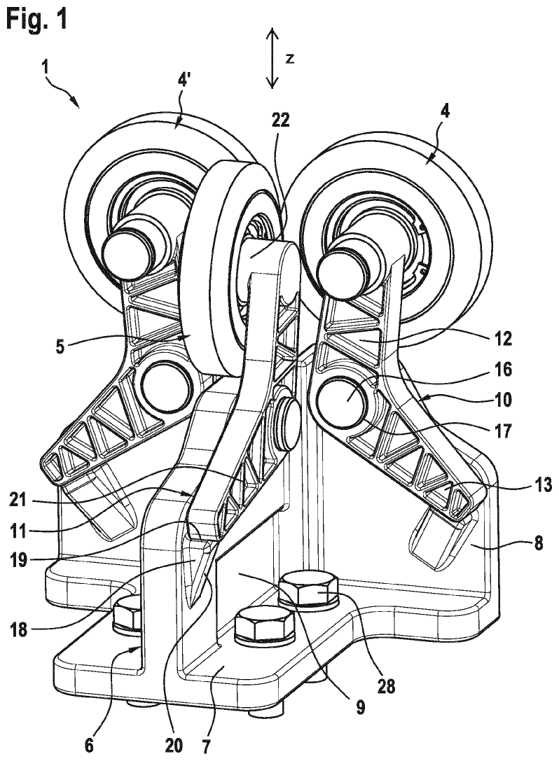

FIG. 1 shows a roller guide shoe, denoted as a whole by reference sign 1, for an elevator. The roller guide shoe 1 is used to guide an elevator car or a counterweight of the elevator along a guide rail (not shown here) extending in the longitudinal direction z. An elevator for a multi-story building may have an elevator shaft, in which an elevator car can be moved vertically up and down to individual floors for transporting people or goods. The elevator can be designed, for example, as a traction elevator system having a counterweight movable in the opposite direction to the elevator car, the support means generally being designed as support cables or belts.

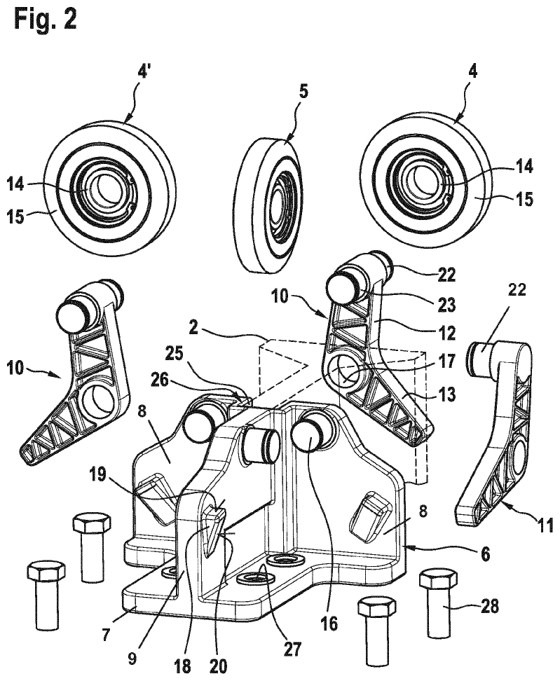

The roller guide shoe 1 shown in FIG. 1 is suitable in particular for guiding along a guide rail which is formed by a T-shaped profile (cf. FIG. 2 below). The T-shaped profile can, for example, be a steel profile manufactured by rolling. Such guide rails 2 have long been known and commonly and widely used. For guiding on a guide rail 2 of this kind, formed as a T-shaped profile, the roller guide shoe 1 has three guide rollers 4, 4′, 5. Each of the guide rollers 4, 4′, 5 is in contact with a guide surface of the guide rail 2 and runs on this during travel of the car.

The roller guide shoe 1 further comprises a support structure 6 having a plate-like base portion 7 and web portions 8, 9 protruding away from the base portion 7. The base portion 7 serves to fasten the roller guide shoe 1 to the elevator car or to the counterweight. In the present case, holes 27 (see FIG. 2) are provided in the base portion 7 for fastening the roller guide shoe 1, through which holes fastening screws 28 are or can be guided, by which the roller guide shoe 1 can be fastened to the guide rail 2, indicated in FIG. 2. For reinforcement, metal sleeves (not shown) can be inserted into the holes 27. The web portions 8, 9 serve to support and carry the guide rollers 4, 4′, 5. The web portions 8 serve to support the two guide rollers 4 and 4′ which are directed toward one another. The guide roller 5, which serves to guide along the front guide surface of the guide rail 2, is assigned to the web portion 9.

Lever elements 10, 11 are arranged in each case between the support structure 6 and the respective guide rollers 4, 4′, 5. The respective guide roller 4, 4′, 5 is in each case mounted so as to be freely rotatable on a free end of the respective lever element 10, 11. The respective lever element 10, 11 has two lever arms 12, 13. The two lever arms 12, 13 are rigidly connected to one another, a recess 17 being provided in the respective lever element 10, 11, centrally between the lever arms 12, 13, for predefining an articulation axis. The lever element 10, 11 is inserted into a joint cam 16, which is arranged laterally on a web portion 8, 9. After insertion, the joint cam 16 engages in the recess 17 on the lever element 10, 11.

The lever element 10, 11 is designed as a bending part, by means of which a preload can be applied, at least in the operationally ready state, for the guide roller 4, 4′, 5. When the roller guide shoe 1 is installed in the elevator, the lever element 10, 11 is arranged in the roller guide shoe 1 such that the lever element 10, 11 is bent, as a result of which a preload is built up by which the guide roller 4, 4′, 5 is pressed against the guide rail 2. This bending is, however, slight, and hardly visible by eye. Thanks to the resilient properties, which can be influenced primarily by the effective length of the lever arm, the shaping, and the material selection, the desired contact pressure for the guide rollers can be set quite precisely. The lever element 10, 11 and in particular the lever arm 12 assigned to the guide roller is elastically deformed in this case. The roller guide shoe 1 can be designed in such a way that the bending, which is necessary for bringing about the preload, is applied as far as possible above the articulation axis, that is to say in the lever arm 12 between the articulation axis and the guide roller, in order not to produce wear by rotation in the joint cam 16.

Clearly, for ensuring sufficiently good travel comfort, the roller guide shoe 1 makes do without additional spring elements, such as helical compression springs or spring means based on elastomers. Another advantage is that such bending parts can be produced cost-effectively in large quantities.

In the present embodiment, the lever element 10, 11 designed as a bending part has a V-shaped configuration. The two lever arms 12, 13 define a V-shape. The lever arms 12, 13 enclose an angle of 120° to 150°. The “V” is consequently formed at an obtuse angle. In principle, however, other shapes for the lever elements 10, 11 would also be conceivable. For example, the lever element 10, 11 could have a curved shape or another shape having one or optionally a plurality of curvatures.

Each of the lever elements 10, 11 has reinforcement ribs 21 extending transversely and provided on the lateral outer contour, for stiffening. Depending on the number, orientation and shape, the reinforcing ribs 21 can also be used to optimally adjust the bending in the lever element for generating the preload.

The respective web portions 8, 9 of the support structure 6 have locking members 18 as an abutment for the respective lever element 10, 11. The locking member 18 is formed as a projection, integrally molded laterally on the support structure 6, and forms a stop for preventing a pivoting movement of the lever element 10, 11 about the articulation axis. The locking member 18 is designed, for example, as a detent, in which the lower lever arm 13 of the lever element 10, 11 is engaged with the detent.

Further structural details of the roller guide shoe 1 can be seen in FIG. 2. The support structure 6 has web portions 8, 9 extending at right angles away from the plate-like base portion 7 for supporting the guide rollers 4, 4′, 5. The web portions 8, 9 clearly form a T-shape in plan view. The web portions 8, 9 protruding away from the base portion 7 in a T-shaped manner are connected to one another via a connecting region, an emergency guide being integrated in this connecting region in such a way that this guide forms an emergency guide channel 25 extending along the web portions 8, 9. In order to form the emergency guide channel 25, channel wall portions 26 are provided, which together form a U-shaped profile part body in plan view. The respective web portions 8, 9 adjoin the associated channel wall portions 26 at a right angle. A metal insert (not shown here) can be provided for strengthening the emergency guide channel 25. This insert can be a metal part which is U-shaped in cross section and is inserted into the emergency guide channel and rests against the channel wall portions 26 after insertion.

The support structure 6 is designed as a one-piece molded body made of a plastics material. Particularly preferably, the support structure 6 is manufactured as an injection-molded part. The support structure 6 can be made of a high-strength plastics material, for example of PE, PP, PA, PS, PES, POM, PEEK, TPEs, in particular the support structure 6 being manufactured from a fiber-reinforced plastics material. In principle, however, other materials would also be conceivable. The support structure 6 could also be made of metal materials, for example an aluminum casting.

Like the support structure 6, the lever elements 10, 11 are likewise integral molded bodies made of plastics material. Numerous advantages arise in particular when the lever elements 10, 11 are plastics parts produced by injection molding. Injection-molded parts can be produced with high precision and economically. Thus, comparatively complicated lever shapes can also readily be produced easily. The bending and preloading for the guide roller 4, 4′, 5 can be generated or adjusted via the geometry and the material of the lever element 10, 11, for which injection-molded parts are particularly well suited. For example, plastics materials such as PE, PP, PA, PS, PES, POM, PEEK, TPEs are possible for the lever element 10, 11. Fiber-reinforced plastics materials, such as glass fiber-reinforced plastics material, are particularly suitable as the material. This material has excellent fatigue strength and ensures the spring property of the lever element over a long time. Since, in contrast to roller guide shoes of conventional design, no additional spring elements (e.g. helical compression springs) have to be used, the roller guide shoe 1 consists of a few components, as a result of which it is easily assembled and has considerable cost advantages. Here, the bending part or the lever element 10, 11 of the roller guide shoe 1 takes over the combined function of a roller carrier and of a spring element. In this case, the spring constant of the lever element 10, 11 can be determined by the lever structure.

In principle, a metal variant of the roller guide shoe 1 would also be conceivable. The support structure 6 could be made of metal materials, for example as an aluminum cast part. The lever elements 10, 11 could also be made of aluminum, for example.

In the present case, the three guide rollers 4, 4′, 5 are guide rollers of identical design. However, it is also conceivable for different guide rollers 4, 4′, 5 to be used. In particular, the guide roller 5 could be designed differently from the guide rollers 4 and 4′. The respective guide roller 4, 4′, 5 comprises an inner bearing bush 14 and an outer wheel rim 15 which is connected to the bearing bush so as to be freely rotatable, via a roller bearing. Both the bearing bush 14 and the wheel rim 15 are preferably made of plastics materials. The wheel rim can be constructed from a plastics component or, if appropriate, from a plurality of plastics components made of different plastics materials. These components can be applied in multiphase injection molding methods. The wheel rim 15 can be designed, for example, as a 2K injection-molded part. In this case, an outer component of the wheel rim 15 would generally have a greater hardness than the inner component.

As can be seen from the exploded view of FIG. 2, the roller guide shoe 1 is constructed from a few components. The roller guide shoe 1 consists essentially of just three components, namely the support structure 6, the lever element 10, 11 and the guide roller 4, 4′, 5. The three lever elements 10, 11 are designed almost identically. The two lever elements 10 for the guide rollers 4, 4′ are designed identically, the lever element 11 for the guide roller 5 differs from the lever elements 10 only in that, for reasons of space, in this case an axle journal 22 is provided only on one side. In principle, however, this lever element 11 could also be of the same design as the lever elements 10, comprising two axle journals 22, 23 (for example in the case of a roller guide shoe comprising guide rollers of a larger diameter).

FIG. 2 also shows how the detent is designed to form the locking member 18. The detent has a contact surface 19, which contacts the lever element 10, 11 when the latching connection is present, and thus specifies a stop. A ramp-like run-on surface 20 adjoins the contact surface 19. The run-on surface 20 is inclined in such a way that, when the lever element is mounted, the relevant lever arm 13 of the lever element 10, 11 can travel along the contact surface of the detent until the end position is reached, in which the lever element 10, 11 or its lever arm is in latching engagement with the detent.

The assembly of the roller guide shoe 1 can take place as follows: First, the support structure 6 is attached to the elevator car or to the counterweight, for example fastened thereto by means of screws 28. The lever elements 10, 11 already provided with the guide rollers 4, 4′, 5 are then mounted on the support structure 6. The guide rollers 4, 4′, 5 can already be pre-mounted or, if necessary, be attached to the lever elements 10, 11 only at the construction site. For mounting the lever elements 10, 11 on the support structure 6, these are brought onto the support structure 6, snapped on or pushed on in the region of the pivot axis by axially pushing their recess 17 onto the joint cams 16, and latched in the locking member. However, locking rings, but also nuts, split pins, etc., which are attached to the joint cam 16, can also be used to secure against unintentional release of the lever elements 10, 11. Securing means could for example also be latching projections on the periphery of the joint cam 16, via which the lever elements 10, 11 are snapped on.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A roller guide shoe for guiding an elevator car or a counterweight of an elevator along a guide rail extending in a longitudinal direction, the roller guide shoe comprising:
a guide roller;
a support structure including a base portion adapted to fasten the roller guide shoe to the elevator car or to the counterweight, and a web portion protruding away from the base portion and carrying the guide roller; and
a lever element arranged between the support structure and the guide roller, the guide roller being rotatably mounted at a free end of the lever element and the lever element engaging the support structure.

17. The roller guide shoe according to claim 16 wherein at least one of the support structure and the lever element is formed as an integral molded body made of a plastics material.

18. The roller guide shoe according to claim 17 wherein at least one of the support structure and the lever element is an injection-molded part.

19. The roller guide shoe according to claim 16 wherein the guide roller has an inner bearing bush and an outer wheel rim rotatably connected to the inner bearing bush, the bearing bush and the wheel rim being formed of at least one plastics material.

20. The roller guide shoe according to claim 16 wherein the lever element is inserted on a joint cam arranged laterally on the web portion, the joint cam engaging in a recess on the lever element, the recess forming an articulation axis of the lever element.

21. The roller guide shoe according to claim 20 wherein the recess is positioned centrally in the lever element.

22. The roller guide shoe according to claim 16 including a locking member on the web portion adapted to abut the lever element.

23. The roller guide shoe according to claim 22 wherein the locking member is formed as a projection from the web portion.

24. The roller guide shoe according to claim 22 wherein the locking member is a detent with which the lever element is in latching engagement when the lever element and the locking member abut.

25. The roller guide shoe according to claim 16 wherein the lever element has two lever arms that define a V-shape of the lever element.

26. The roller guide shoe according to claim 25 wherein the two lever arms enclose an angle of 120° to 150°.

27. The roller guide shoe according to claim 16 wherein the lever element has reinforcing ribs or reinforcing webs.

28. The roller guide shoe according to claim 16 wherein the lever element has at the free end an axle journal integrally formed laterally on which the guide roller is received.

29. A roller guide shoe for guiding an elevator car or a counterweight of an elevator along a guide rail extending in a longitudinal direction, the roller guide shoe comprising:
three guide rollers;
a support structure including a base portion adapted to fasten the roller guide shoe to the elevator car or to the counterweight; and
three lever elements arranged on the support structure, each of the lever elements having an associated one of the guide rollers rotatably mounted thereon, wherein two of the lever elements each have two coaxial axle journals adapted to receive the guide rollers, the axle journals being arranged on opposite sides of each of the two the lever elements.

30. The roller guide shoe according to claim 29 wherein the support structure has three web portions that project away from the base portion at right angles, each of the web portions supporting an associated one of the lever elements with the associated guide roller, the support structure having an emergency guide integrated therein forming an emergency guide channel extending along the web portions at a connecting region of the web portions.

31. The roller guide shoe according to claim 30 wherein the emergency guide channel is formed by channel wall portions and is U-shaped in profile, each of the web portions adjoining an associated one of the channel wall portions at a right angle.
